(19) United States
(12) Patent Application Publication
(10) Pub. No.: US 2015/0325923 A1
(43) Pub. Date: Nov. 12, 2015

(54) ANTENNA

(71) Applicant: NIHON DENGYO KOSAKU CO., LTD., Chiyoda-ku, Tokyo (JP)

(72) Inventor: Hidenobu HIRAMATSU, Tokyo (JP)

(73) Assignee: NIHON DENGYO KOSAKU CO., LTD., Chiyoda-ku, Tokyo (JP)

(21) Appl. No.: 14/442,006

(22) PCT Filed: Nov. 14, 2013
(86) PCT No.: PCT/JP2013/080767

§ 371 Date: May 11, 2015

(30) Foreign Application Priority Data
Nov. 29, 2012 (JP) 2012-260765

(51) Int. Cl. H01Q 19/10; H01Q 21/24

(52) U.S. Cl. CPC H01Q 19/108; H01Q 21/24

(57) ABSTRACT

The antenna is provided with: a conductor; an EBG structure that is disposed above the conductor and that contains plural square elements arranged in a matrix; and a radiation element disposed above the EBG structure. A distance L1 between the conductor and the EBG structure satisfies 0.01λ₀≦L1≦0.15λ₀, preferably satisfies 0.025λ₀≦L1≦0.085λ₀, and more preferably satisfies 0.035λ₀≦L1≦0.07λ₀, where an wavelength of a design center frequency of the radiation element is denoted by λ₀.

### TECHNICAL FIELD

The present invention relates to an antenna, and specifically to an antenna in which an electromagnetic band gap (EBG) structure is used as a reflector.

### BACKGROUND ART

An indoor antenna, which is mounted on, for example, a ceiling, is required to have a planar structure and to be thin in consideration of the installation and the appearance.

An EBG structure with a technology in meta-materials is used as a reflector, which enables an antenna to have a lower profile.

Patent document 1 suggests a dual-band antenna disposed above an EBG reflector.

### CITATION LIST

### Patent Literature

Patent Document 1: Japanese Patent Application Laid-Open Publication No. 2005-94360

### SUMMARY OF INVENTION

### Technical Problem

However, the EBG structure has high frequency dependence and a narrow band. Thus the antenna having the EBG structure used as the reflector has a problem of narrowband frequency characteristics.

The present invention is to address the aforementioned problem of the conventional art, and an object of the present invention is to provide an antenna having a low profile and wideband characteristics with a reflector having an EBG structure.

The aforementioned object, another object and a novel feature of the present invention will be clarified in this specification and attached drawings.

### Solution to Problem

The following is a brief summary of the representative elements of the invention disclosed in this application:
(1) A conductor, an EBG structure that is disposed above the conductor and that contains plural square elements arranged in a matrix, and a radiation element disposed above the EBG structure are provided. A distance L1 between the conductor and the EBG structure satisfies 0.01λ₀≦L1≦0.15λ₀, preferably satisfies 0.025λ₀≦L1≦0.085λ₀, and more preferably satisfies 0.035λ₀≦L1≦0.07λ₀, where an wavelength of a design center frequency of the radiation element is denoted by λ₀.
(2) In (1), a square element located in a section corresponding to the radiation element has been removed from the EBG structure.
(3) In any one of (1) and (2), the radiation element has a parasitic element.

### Advantageous Effects of Invention

The effect obtained by the representative elements of the invention disclosed in this application will be briefly explained as follows.

According to the present invention, it is possible to provide an antenna having a low profile and wideband characteristics with the reflector having the EBG structure.

### BRIEF DESCRIPTION OF DRAWINGS

FIG. 1 is a perspective view for illustrating a schematic configuration of the antenna of the example 1 of this invention;

FIG. 2 is a cross-sectional view of the antenna of the example 1 of this invention;

FIG. 3 is a plane view of the EBG structure of the antenna of the example 1 of this invention;

FIG. 4 is a plane view of the radiation element of the antenna of the example 1 of this invention;

FIG. 5 is a graph showing the return loss characteristics of the antenna of the example 1 of this invention;

FIG. 6 is a graph showing the change of the specific band width having the return loss of −10 dB upon keeping the distance between the radiation element and the EBG structure (L2-L1 in FIG. 2) constant and changing the distance between the reflector and the radiation element (L2 in FIG. 2) in the antenna of the example 1 of this invention;

FIG. 7 is a plane view of a radiation element of an antenna of the example 2 of this invention;

FIG. 8 is a graph showing the return loss characteristics of the antenna of the example 2 of this invention;

FIG. 9 is a plane view of an EBG structure of an antenna of the example 3 of this invention;

FIG. 10 is a graph showing the return loss characteristics of the antenna of the example 3 of this invention; and

FIG. 11 is a graph showing return loss characteristics of an antenna of a comparative example for comparison of the antenna of the first example of this invention.

### DESCRIPTION OF EMBODIMENTS

Hereinafter, examples of the present invention will be described in detail with reference to attached drawings.

Note that the same reference numerals are used for elements having the same functions in all drawings for illustrating the examples, and description thereof is not repeated. The examples described below are not intended to limit the scope of claims of the invention.

### Example 1

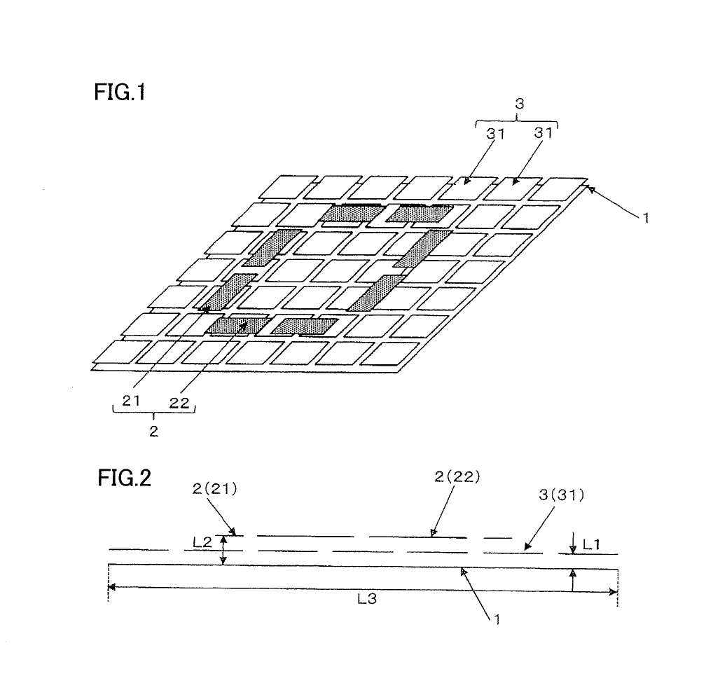

FIGS. 1 to 4 are views for illustrating one example of an antenna according to the example 1 of this invention.

FIG. 1 is a perspective view for illustrating a schematic configuration of the antenna of this example,

FIG. 2 is a cross-sectional view of the antenna of this example,

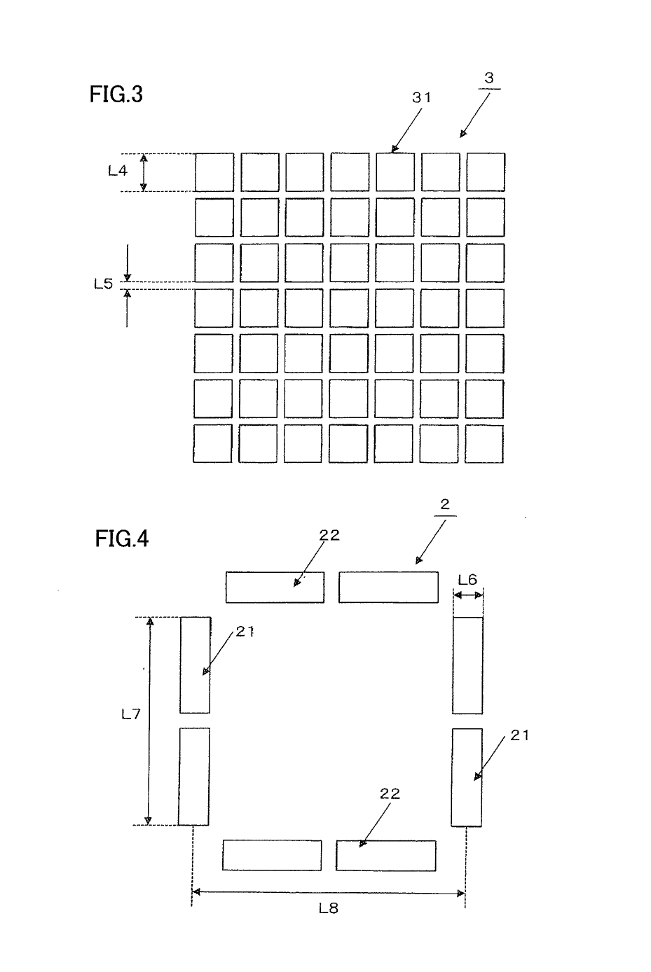

FIG. 3 is a plane view of an EBG structure 3 of the antenna of this example, and

FIG. 4 is a plane view of a radiation element 2 of the antenna of this example.

The antenna of this example includes: a reflector 1 made of a metal plate; the electromagnetic band gap (EBG) structure 3 disposed above the reflector 1; and the radiation element 2 disposed above the EBG structure 3.

As shown in FIGS. 1 and 2, the radiation element 2 is configured by a pair of dipole antennas 21 for vertical polarization and a pair of dipole antennas 22 for horizontal polarization. Each of the pair of the dipole antenna elements 21 for the vertical polarization and the pair of the dipole antennas 22 for the horizontal polarization may be formed on a dielectric substrate using a printed-circuit technology, or may be made of a metal rod, tube or the like.

Note that, for example, a vertical polarization patch antenna, a horizontal polarization patch antenna, or a dual-polarization patch antenna can be used as the radiation element 2.

As shown in FIG. 3, the EBG structure 3 has 7*7 square elements 31 arranged in a matrix. The EBG structure 3 may be formed on a dielectric substrate using a printed-circuit technology, or may be made of a metal plate.

Note that the number of the square elements 31 arranged in the matrix may be increased or decreased according to the desired radiation-pattern characteristics.

The EBG structure 3 makes a unique impedance face since an inductance of the square element 31 as a core and a capacitance with the adjacent square element 31 are formed. Appropriate selection of the size of the square elements 31 of the EBG structure 3 and the distance there between achieves an appropriate impedance face, and a large effect can be obtained.

In this example, the distance between the reflector 1 and the EBG structure 3 (L1 in FIG. 2) is 0.05λ₀, and the distance between the reflector 1 and the radiation element 2 (L2 in FIG. 2) is 0.1λ₀, where the free-space wavelength of the design center frequency f₀ of the antenna is denoted by λ₀.

The length of one side of the reflector 1 (L3 in FIG. 2) is 1.52λ₀.

The length of one side of the square element 31 of the EBG structure (L4 in FIG. 3) is 0.2λ₀, and the distance from the adjacent square element 31 (L5 in FIG. 3) is 0.02λ₀.

The width of the pair of the dipole antenna elements 21 for the vertical polarization and the width of the pair of the dipole antennas 22 for the horizontal polarization configuring the radiation element 2 shown in FIG. 4 (L6 in FIG. 4) are each 0.12λ₀, the length of the pair of the dipole antenna elements 21 for the vertical polarization and the length of the pair of the dipole antennas 22 for the horizontal polarization (L7 in FIG. 4) are each 0.46λ₀, and the distance between the dipole antenna elements 21 for the vertical polarization and the distance between the dipole antennas 22 for the horizontal polarization (L8 in FIG. 4) are each 0.64λ₀.

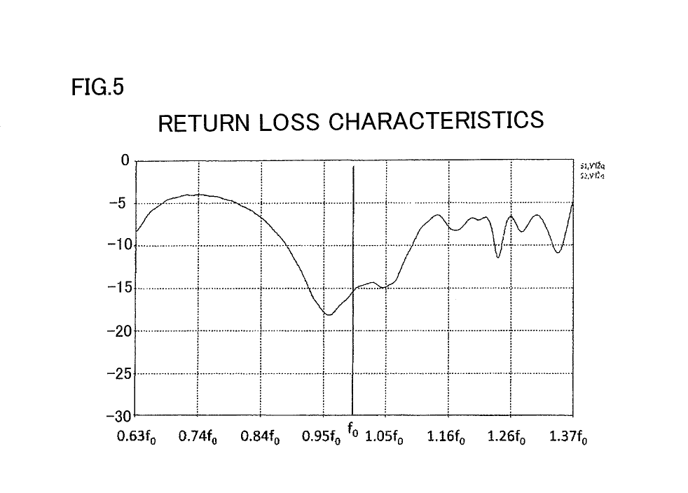

FIG. 5 is a graph showing the return loss characteristics of the antenna of this example.

As suggested in FIG. 5, the specific band width of the frequency characteristics having the return loss of −10 dB or below (that is, the specific band width of the frequency characteristics having VSWR ≦2) is 22.3% in the antenna of this example. Note that the design center frequency f₀ is 1.9 GHz, and the free-space wavelength λ₀ of the design center wavelength f₀ is 157.9 mm in the graph of FIG. 5.

The specific band width of the frequency characteristics is represented by (fwide*100)/f₀. Here, fwide is a frequency band having the return loss of −10 dB or below.

FIG. 11 is a graph showing return loss characteristics of an antenna of a comparative example for comparison of the antenna of this example.

The antenna of the comparative example shown in FIG. 11 has the same specifications except for the distance between the reflector 1 and the EBG structure 3 (L1 in FIG. 2) set to 0.006λ₀.

As suggested in FIG. 11, the specific band width of the frequency characteristics having the return loss of −10 dB or below (that is, the specific band width of the frequency characteristics having VSWR ≦2) is 7.6% in the antenna of the comparative example. Note that, also in the graph of FIG. 11, the design center frequency f₀ is 1.9 GHz, and the free-space wavelength λ₀ of the design center wavelength f₀ is 157.9 mm.

As described above, the increase of the distance between the reflector 1 and the EBG structure 3 (L1 in FIG. 2) leads to widening of the frequency characteristics in this example, and thus it is possible to provide an antenna having a low profile and wideband characteristics according to this example.

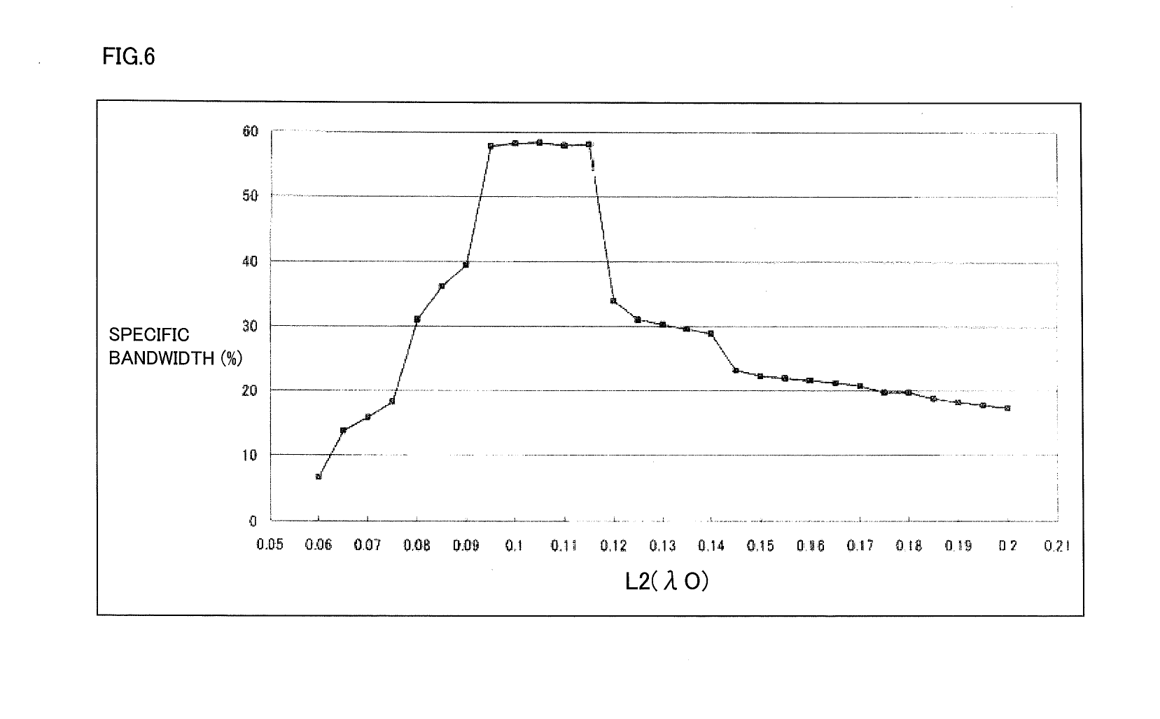

FIG. 6 is a graph showing the change of the specific band width having the return loss of −10 dB upon keeping the distance between the radiation element 2 and the EBG structure 3 (L2-L1 in FIG. 2) constant (0.05λ₀) and changing the distance between the reflector 1 and the radiation element 2 (L2 in FIG. 2) in the antenna of this example.

From the graph shown in FIG. 6, the distance between the reflector 1 and the EBG structure 3 (L1 in FIG. 2) may be 0.01λ₀≦L1≦0.15λ₀, preferably 0.025λ₀≦L1≦0.08λ₀, and more preferably 0.035λ₀≦L1≦0.07λ₀ for achieving the wideband characteristics in the antenna of this example.

### Example 2

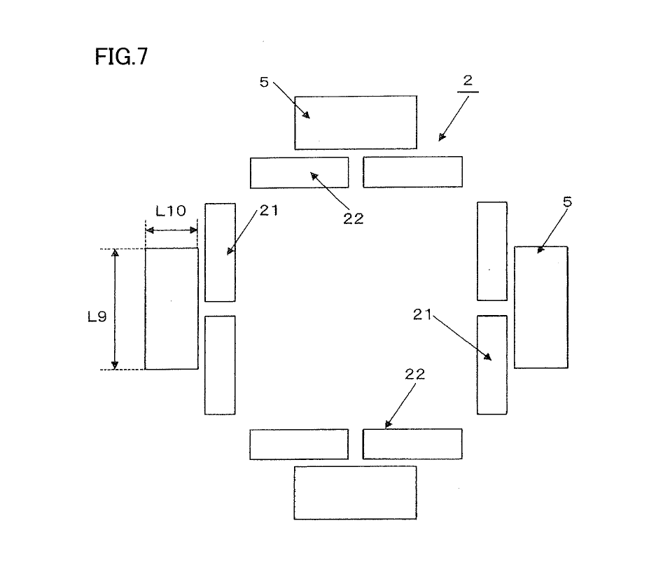

FIG. 7 is a plane view of a radiation element 2 of an antenna of this example.

The antenna of the example 2 of this invention has, as shown in FIG. 7, difference from the aforementioned antenna of the example 1, in which the pair of the dipole antennas 21 for the vertical polarization and the pair of the dipole antennas 22 for the horizontal polarization configuring the radiation element 2 have parasitic elements 5.

In FIG. 7, the width of the parasitic elements 5 (L10 in FIG. 7) is 0.18λ₀, and the length of the parasitic elements 5 (L9 in FIG. 7) is 0.25λ₀.

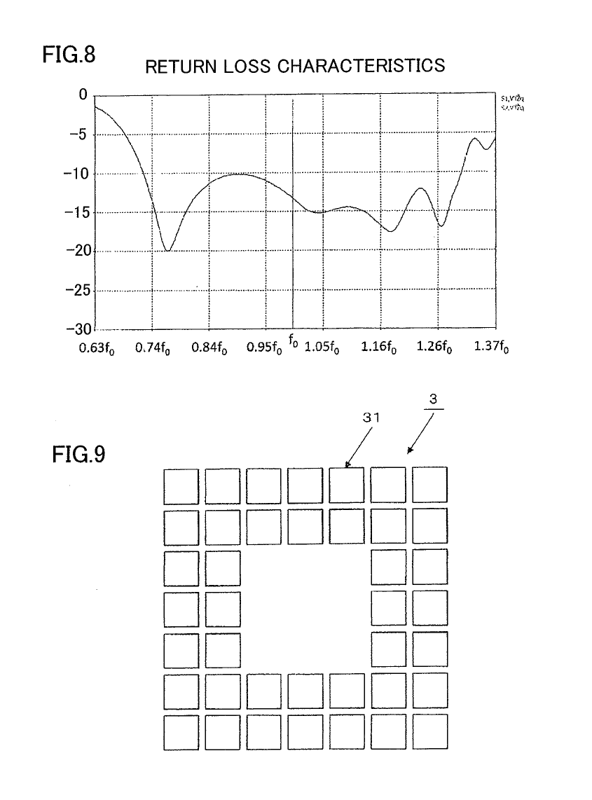

FIG. 8 is a graph showing the return loss characteristics of the antenna of this example.

As suggested in FIG. 8, the specific band width of the frequency characteristics having the return loss of −10 dB or below (that is, the specific band width of the frequency characteristics having VSWR ≦2) is 58.2% in the antenna of this example. Note that the design center frequency f₀ is 1.9 GHz, and the free-space wavelength λ₀ of the design center wavelength f₀ is 157.9 mm in the graph of FIG. 8.

As described above, the parasitic elements 5 are provided to the pair of the dipole antennas 21 for the vertical polarization and the pair of the dipole antennas 22 for the horizontal polarization configuring the radiation element 2 in the antenna of the aforementioned example 1, and thereby wider-band characteristics can be obtained in comparison with the antenna of the aforementioned example 1.

### Example 3

FIG. 9 is a plane view of an EBG structure of an antenna of the example 3 of this invention.

The antenna of the example 3 of this invention has difference from the aforementioned antenna of the example 2, in which the central nine (=3*3) square elements 31 of the EBG structure 3 has been removed as illustrated in FIG. 9.

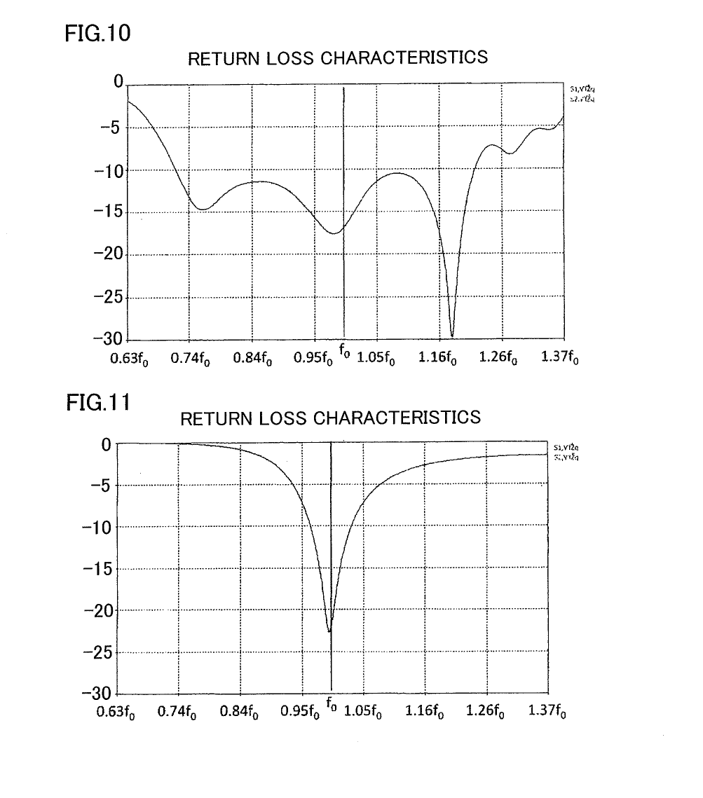

FIG. 10 is a graph showing the return loss characteristics of the antenna of the example 3 of this invention.

As suggested in FIG. 10, the specific band width of the frequency characteristics having the return loss of −10 dB or below (that is, the specific band width of the frequency characteristics having VSWR ≦2) is 52.8% in the antenna of this example. Note that the design center frequency f₀ is 1.9 GHz, and the free-space wavelength λ₀ of the design center wavelength f₀ is 157.9 mm in the graph of FIG. 10.

As described above, the central nine (=3*3) square elements 31 of the EBG structure 3 has been removed from the antenna of the aforementioned example 2, and thereby feeding to the pair of the dipole antennas 21 for the vertical polarization and the pair of the dipole antennas 22 for the horizontal polarization configuring the radiation element 2 is easy in this example in comparison with the aforementioned example 2 since feed lines can be arranged in the removed part of the central nine (=3*3) square elements 31 of the EBG structure 3, although the specific band width of the frequency characteristics is slightly narrowed in comparison with the aforementioned antenna of the example 2.

Note that the central nine (=3*3) square elements 31 of the EBG structure 3 can be also removed from the aforementioned antenna of the example 1.

The invention made by the inventor has been explained specifically on the basis of the examples, but this invention is not limited to the aforementioned examples. It should be clear that various modifications can be made without departing from the gist of this invention.

### REFERENCE SIGNS LIST

1 . . . Reflector
2 . . . Radiation element
3 . . . Electromagnetic band gap (EBG) structure
5 . . . parasitic element
21 . . . Pair of dipole antennas for vertical polarization
22 . . . Pair of dipole antennas for horizontal polarization
31 . . . Square element

1. An antenna comprising:
a conductor;
an EBG structure that is disposed over the conductor with air space there between and contains a plurality of square elements arranged in a matrix; and
a radiation element disposed above the EBG structure, wherein
distance L1 between the conductor and the EBG structure satisfies 0.01λ₀≦L1≦0.15λ₀, where an wavelength of a design center frequency of the radiation element is denoted by λ₀, and
each of the plurality of square elements in the EBG structure galvanically isolated from both the conductor and the others of the plurality of square elements.

2. The antenna according to claim 1, wherein
the radiation element comprises:
one pair of dipole elements transmitting and receiving one linearly polarized wave, the dipole elements being arranged in parallel; and
another pair of dipole elements transmitting and receiving another linearly polarized wave orthogonal to the one linearly polarized wave, the dipole elements of the another pair being disposed in parallel, wherein
the one pair of the dipole elements and the another pair of the dipole elements are disposed so that a line connecting centers of the dipole elements of the one pair intersects with a line connecting centers of the dipole elements of the another pair.

3. The antenna according to claim 1, wherein
the distance L1 between the conductor and the EBG structure satisfies 0.025λ₀≦L1≦0.085λ₀.

4. The antenna according to claim 3, wherein
the distance L1 between the conductor and the EBG structure satisfies 0.035λ₀≦L1≦0.07λ₀.

5. The antenna according to claim 1, wherein
a square element located in a section corresponding to the radiation element has been removed from the EBG structure.

6. The antenna according to claim 1, wherein
the radiation element comprises a parasitic element.
